(19) United States
(12) Patent Application Publication
(10) Pub. No.: US 2015/0363809 A1
(43) Pub. Date: Dec. 17, 2015

(54) Endorsements Used in Ranking Ads

(71) Applicant: Google Inc., Mountain View, CA (US)

(72) Inventors: Bob Purvy, San Jose, CA (US); H. Hadon Nash, Mountain View, CA (US); Carl S. Shapiro, Palo Alto, CA (US); Tania Bedrax-Weiss, Sunnyvale, CA (US)

(21) Appl. No.: 14/746,419

(22) Filed: Jun. 22, 2015

Related U.S. Application Data
(63) Continuation of application No. 12/761,967, filed on Apr. 16, 2010.

(51) Int. Cl. G06Q 30/02; G06Q 50/00

(52) U.S. Cl. CPC G06Q 30/0214; G06Q 30/0257; G06Q 50/01

(57) ABSTRACT

Methods, systems, and apparatus, including computer programs encoded on a computer storage medium, for providing advertisements. In one aspect, a method includes receiving a request for an advertisement from a user device associated with a first user, and identifying advertisements responsive to the request. A determination is made that one of the advertisements describes a good or service that is associated with an endorsement provided by an endorser, and the endorser is recommended by a second user that belongs to a same social network as the first user. The advertisements are ranked based on one or more signals associated with each advertisement, wherein one of the signals for the one advertisement is the endorsement and is used in the ranking in response to the determination. The ranked advertisements are provided in response to the request.

### CROSS-REFERENCE TO RELATED APPLICATIONS

This application is a continuation application of and claims priority to U.S. application Ser. No. 12/761,967, filed on Apr. 16, 2010. This application is related to U.S. patent application Ser. No. 12/762,039, filed on Apr. 16, 2010, Attorney Docket No. 16113-2034001, entitled “Social Network Endorsements and Recommendations,” and U.S. patent application Ser. No. 12/762,261, filed on Apr. 16, 2010, Attorney Docket No. 16113-2272001, entitled “Payment Model With Endorsements.” Each of these applications are incorporated by reference.

### BACKGROUND

This specification relates to data processing and content selection.

The Internet enables access to a wide variety of resources. For example, video, audio, webpages directed to particular subject matter, news articles, images, and other resources are accessible over the Internet. The wide variety of resources that are accessible over the Internet has enabled opportunities for advertisers to provide targeted advertisements with the resources. For example, an advertisement can be targeted for presentation with resources directed to subject matter to which the advertisement is relevant.

Users who are provided the advertisements with the resources often rely on third-party websites for reviews of goods or services to determine whether the goods or services in the advertisements have received positive reviews and whether others are satisfied with the goods or services. However, the reliability of the reviews provided by these websites may depend on whether the writer of a review is unbiased and trustworthy. For example, a merchant can reduce the reliability of reviews by hiring reviewers to provide favorable reviews of the merchant's products or to provide negative reviews of a competitor's products.

### SUMMARY

In general, one innovative aspect of the subject matter described in this specification can be implemented by methods that include the actions of receiving a request for an advertisement from a user device associated with a first user; identifying advertisements responsive to the request; determining that one of the advertisements describes a good or service that is associated with an endorsement provided by an endorser, and that the endorser is recommended by a second user that belongs to a same social network as the first user; ranking the advertisements based on one or more signals associated with each advertisement, wherein one of the signals for the one advertisement is the endorsement and is used in the ranking in response to the determination; and providing the ranked advertisements in response to the request. Other implementations may include corresponding systems, apparatus, and computer programs, configured to perform the actions of the methods, encoded on computer storage devices.

These and other implementations can each optionally include one or more of the following features. The methods can include receiving from the endorser, the endorsement for the good or service; and associating the endorsement with the advertisement describing the good or service. The methods can also include determining that the endorsement is associated with a recommendation of the endorser. The methods can also include identifying a first user that provided the request for the advertisement; identifying a second user that provided the recommendation of the endorser; and determining that the first user and the second user belong to the same social network.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example webpage that displays advertisements with endorsements.

FIG. 2 is a block diagram of an example advertisement system environment.

FIG. 3 is a block diagram of an example process flow for providing advertisements associated with endorsements.

FIG. 4 is a block diagram of an example process flow for displaying advertisements associated with endorsements.

FIG. 5 is a block diagram of an example process flow for providing ranked advertisements.

FIG. 6 is a block diagram of an example process flow for providing compensation to endorsers of advertisements.

FIG. 7 is a block diagram of an example process flow for providing advertisements associated with endorsements

FIG. 8 is a block diagram of an example computer system that can be used to facilitate selection and providing of advertisements associated with endorsements.

Like reference numbers and designations in the various drawings indicate like elements.

### DETAILED DESCRIPTION

An endorsement subsystem receives endorsements of advertisements from endorsers, and associates the endorsements with the advertisements. The endorser for an advertisement may have expertise in a category associate with the advertisement. The endorsement subsystem also receives recommendations of the endorsers from users. When an advertisement is provided in response to a request for an advertisement from a first user, the endorsement subsystem provides an advertisement that has been endorsed by another user that shares an acquaintance relationship with the first user in a social network. The endorsement subsystem can also provide a recommendation of the endorser if the endorser has been recommended. The endorsement subsystem provides the advertisement, the endorsement of the advertisement, and the recommendation of the endorser in response to the request.

A social network (e.g., FACEBOOK, MYSPACE, ORKUT, LINKEDIN, TWITTER) can be an online system that provides a forum for users who are geographically separated from each other to interact with one another, where those users have defined a relationship between one another. A user of a social network can have a profile page (e.g., a webpage on the social network) that provides information about the user to other users of the social network. A profile can include information regarding a user's acquaintance relationships (e.g., friends, colleagues, schoolmates) on the social network. Users can control who can view their information by identifying particular relationships with other users, and a user can also define relationships with new users from the group of other users who have relationships with users with whom the user already has relationships.

The social network can also have a mobile component. A mobile profile, mobile location, mobile data, applications shared, game sharing, music shared, and call, chat, and short message service (SMS) information can also be used for a social graph analysis. A social graph represents entities and interactions (connections) between users/entities in the social network. Users are represented as nodes in the graph and interactions are represented as lines connecting the nodes. Each of the nodes and connections can be stored as objects or otherwise defined in a data structure stored on a computer-readable storage device. Interactions, for example, can involve communications between two individual users. A pair of users may become involved in multiple interactions. The social graph analysis can be built with proper privacy-preserving restrictions, without Personally Identifiable Information (PII), and with user permission.

When more than one advertisement in response to a request for an advertisement is identified, the endorsement subsystem can rank the advertisements based on signals associated with each advertisement. If the advertisement was endorsed, one of the signals is the endorsement. The endorsement subsystem can then rank the advertisements according to a score calculated based on the signals and provide the ranked advertisements in response to the request.

If an advertisement with an endorsement is presented in response to the search query and the advertisement was selected by the user that provided the request, the endorsement subsystem can compensate the endorser upon receiving an indication of the selection of the advertisement.

In some implementations, an endorsement subsystem is implemented as an element of a query processing system that operates in an online environment. In other implementations, the endorsement subsystem is implemented in a processing system separate from the query processing system. In these implementations, the endorsement subsystem communicates over a network or directly with the query processing system.

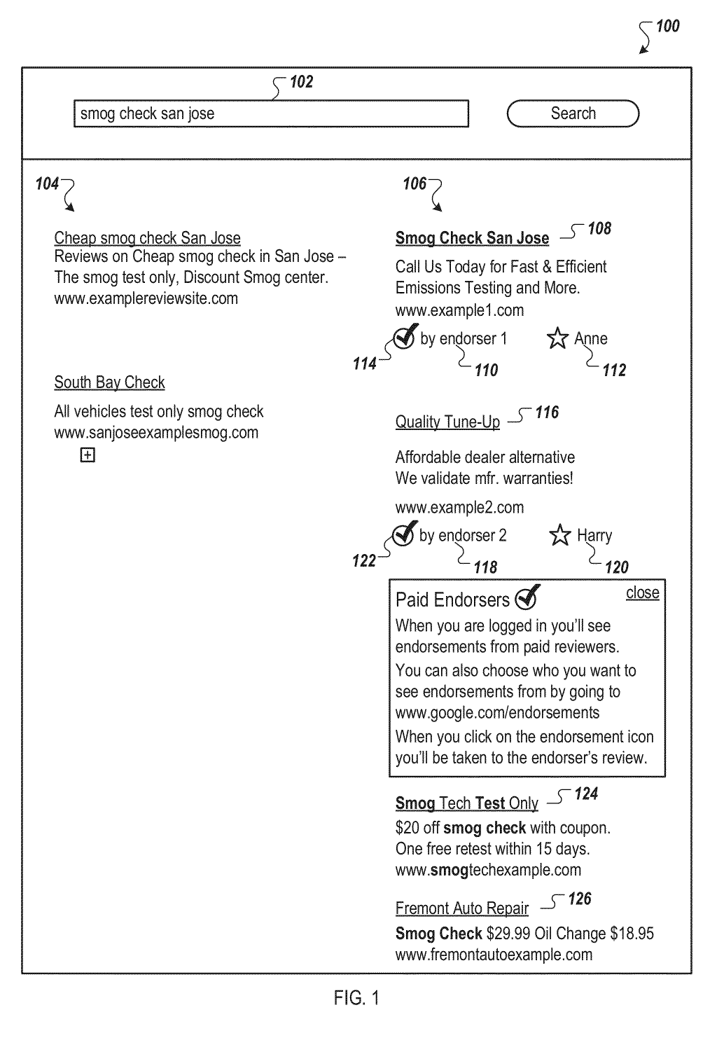

FIG. 1 shows an example webpage 100 that displays a search query 102 provided by a user, search results 104, and advertisements 106 responsive to the search query 102. An endorsement subsystem identifies whether or not the user belongs to a social network. For example, suppose the user performing this search is Mike who belongs to a social network A.

In response to the search query “smog check San Jose” 102 by Mike, the endorsement subsystem identifies the search results as well as eligible advertisements that are responsive to the search query 102. The endorsement subsystem determines whether any of the eligible advertisements have been endorsed by another user that also belongs to social network A. For example, suppose advertisement 108 was the only advertisement responsive to the search query 102. The endorsement subsystem determines that the goods or services described by advertisement 108 were endorsed by endorser 1, 110 and that endorser 1, 110 was recommended by Anne 112. For example, Anne may trust endorser 1, 110 to endorse smog checks. The endorsement subsystem then determines that Anne 112 belongs to social network A. Therefore, since Anne and Mike belong to the same social network, the endorsement subsystem provides advertisement 108 in response to Mike's search query.

The endorsement subsystem can also determine whether the users share an acquaintance relationship in the same social network, and provide the advertisement in response to a query only if the users share an acquaintance relationship. Thus, using the example provided above, the endorsement subsystem would provide advertisement 108 in response to Mike's search query when Anne and Mike have an acquaintance relationship in social network A, and would not provide advertisement 108 when Anne and Mike do not have an acquaintance relationship.

The webpage 100 also displays an indication 114 that the goods or services described by advertisement 108 were endorsed by endorser 1, 110. In this example, the indication 114 is a checkmark. The indication 114 provides a visual indication of the endorsement to the user Mike. Mike can also click on the checkmark and either be shown comments that may accompany the endorsement in an area proximate to the advertisement 108, or can be taken to another webpage that will display the comments about the endorsement.

In some implementations, an advertiser associated with the advertisement can be endorsed. For example, endorser 1, 110 can endorse the advertiser www.example1.com. The endorsement subsystem can determine that the advertiser associated with advertisement 108 was endorsed by endorser 1, 110, and that endorser 1, 110 was recommended by Anne 112. The endorsement subsystem then determines that Anne and Mike belong to social network A and, for this reason, the endorsement subsystem provides advertisement 108 in response to Mike's search query.

In some implementations, an advertisement can be endorsed. For example, endorser 1, 110 can endorse the advertisement 108. The endorsement subsystems can determine that the advertisement 108 was endorsed by endorser 1, 110, and that endorser 1, 110 was recommended by Anne 112. The endorsement subsystem then determines that Anne and Mike belong to social network A and, for this reason, the endorsement subsystem provides advertisement 108 in response to Mike's search query.

In some implementations, clicking on the indication 114 of the endorsement displays to the user why the endorsement is being displayed to the user. The endorsement subsystem allows the user to select the endorsers from which they want to see endorsements. Alternatively, the system can provide an indication of a webpage that allows the user to change these settings. For example, if Mike clicks on the indication and changes settings so that he no longer sees these endorsements, the next time an advertisement with an endorsement is identified in response to a search query by Mike, the endorsement will not be provided with the advertisement.

In this example, more than one advertisement was responsive to the search query 102. Mike can see all the advertisements 106 but may not know which goods, services, or ideas in the advertisements are reputable. Mike sees that the goods or services described in advertisement 108 have been endorsed by endorser 1, 110, as indicated by the checkmark. In this example, endorser 1 is an expert in the area of smog checks and therefore has endorsed the goods or services described by advertisement 108. Endorser 1, 110 could have alternatively endorsed the advertiser associated with advertisement 108, or the actual advertisement 108. In this example, the checkmark would still show that the advertiser associated with advertiser 108 or the actual advertisement 108 have been endorsed by endorser 1, 110.

Mike also sees that endorser 1, 110 has been recommended as an endorser by Anne 112. Anne is a user that belongs to social network A. Mike may therefore recognize Anne from his social network. On the other hand, if Mike did not recognize Anne, he can alternatively click on her name on the webpage 100, and the webpage 100 can respond by presenting the social network they share to Mike in an area proximate to her name. Therefore, Mike knows that the goods or services described in advertisement 108 have been endorsed by an endorser recommended by someone in his social network.

Anne and Mike may also share an acquaintance relationship. For example, Anne and Mike may have gone to college together. If Mike did not recognize Anne, he could click on her name on the webpage 100, and the webpage 100 can respond by presenting the acquaintance relationship they share to Mike in the area proximate to her name. The webpage 100 also displays advertisement 116, which includes goods or services that have been endorsed by endorser 2, 118 as indicated by the checkmark 122. Endorser 2, 118 has been recommended as an endorser by Harry 120. Suppose Harry is a user that belongs to social network A. The endorsement subsystem determines that Harry also belongs to social network A, and, therefore, that the endorsement of the goods or services described in advertisement 116 would be shown. For example, the social network A could be a messaging social network.

In other implementations, only endorsements that have been recommended by someone having acquaintance relationship in the social network with the user performing the search will be displayed on the webpage 100. In this example, the endorsement of the goods or services described in advertisement 116 would not be shown since Harry 120, the user who recommended endorser 2, 118, does not share an acquaintance relationship with Mike.

If more than one advertisement is identified by the endorsement subsystem in response to Mike's request, the endorsement subsystem ranks the advertisements according to a score calculated based on signals associated with each advertisement. One of the signals is based on whether or not the goods or services described in advertisement were endorsed. Another signal is based on whether the endorser was recommended by someone in the same social network as the person who provided the search query. Another signal is based on whether or not the advertisement itself was endorsed, or if the advertiser associated with the advertisement was endorsed. Another signal is based on whether the endorser was recommended by someone having an acquaintance relationship in the same social network as the person who provided the search query. Each of these signals is given a weight, and the weight is used when calculating the score used to rank the advertisements.

In this example, four advertisements 106 (advertisements 108, 116, 124, and 126) were identified in response to the request for “smog check san Jose.” The endorsement subsystem ranks the advertisements 106 according to a score calculated using the signals associated with the advertisements. The advertisements 106 that include goods or services that were endorsed, or advertisements that themselves were endorsed, or advertisements associated with advertisers that were endorsed are scored higher and therefore ranked higher.

As shown, goods or services in advertisements 108 and 116 were both endorsed and therefore are displayed higher than advertisements 124 and 126. Furthermore, since advertisement 108 was recommended by Anne, who has an acquaintance relationship with Mike in the social network, and advertisement 116 was recommended by Harry, who belongs to the social network but does not have an acquaintance relationship with Mike, the endorsement subsystem uses the recommendation by Anne is also used as a signal in the score calculation of advertisement 108. Advertisement 108 is therefore ranked higher than advertisement 116 even though both advertisements include goods or services that were endorsed and recommended, because Anne has an acquaintance relationship with Mike and Harry does not.

The endorsement subsystem also compensates an endorser if the goods or services in an advertisement endorsed by the endorser is selected by a user or if the selection by the user leads to a conversion. The endorsement subsystem also compensates an endorser if the advertisement is endorsed or if the advertiser associated with the advertisement is endorsed. For example, if Mike selects advertisement 108, endorser 1, 110 may be compensated by the endorsement subsystem. If Mike selects the advertisement 116, endorser 2, 118 may be compensated by the endorsement subsystem.

In some implementations, the endorsement subsystem only compensates the endorsers that are recommended by someone who is in a same social network as the user who provided the initial search query. Therefore, in this example, if Mike selected advertisement 116, the endorsement subsystem compensates endorser 1, 110 and endorser 2, 118 because Anne and Harry both belong to the social network A with Mike.

In other implementations, the endorsement subsystem only compensate the endorsers that are recommended by someone who shares an acquaintance relationship in the same social network as the user who provided the initial search query. Therefore, in this example, if Mike selected advertisement 116, the endorsement subsystem does not compensates endorser 2, 118 because Harry does not have an acquaintance relationship with Mike, even though they both belong to the social network A. The endorsement subsystem only compensates endorser 1, 110 because Anne and Mike share an acquaintance relationship in the social network.

In some implementations, the compensation is based on a percentage of the cost-per-click (CPC) for each advertisement. For example, each advertisement is associated with a CPC than an advertiser associated with the advertisement has indicated it will pay for each selection of the advertisement. For example, if advertisement 108 is associated with a CPC of $0.50, endorser 1, 110 can be compensated a percentage (e.g., 10%) of $0.50 when Mike selects the advertisement 108.

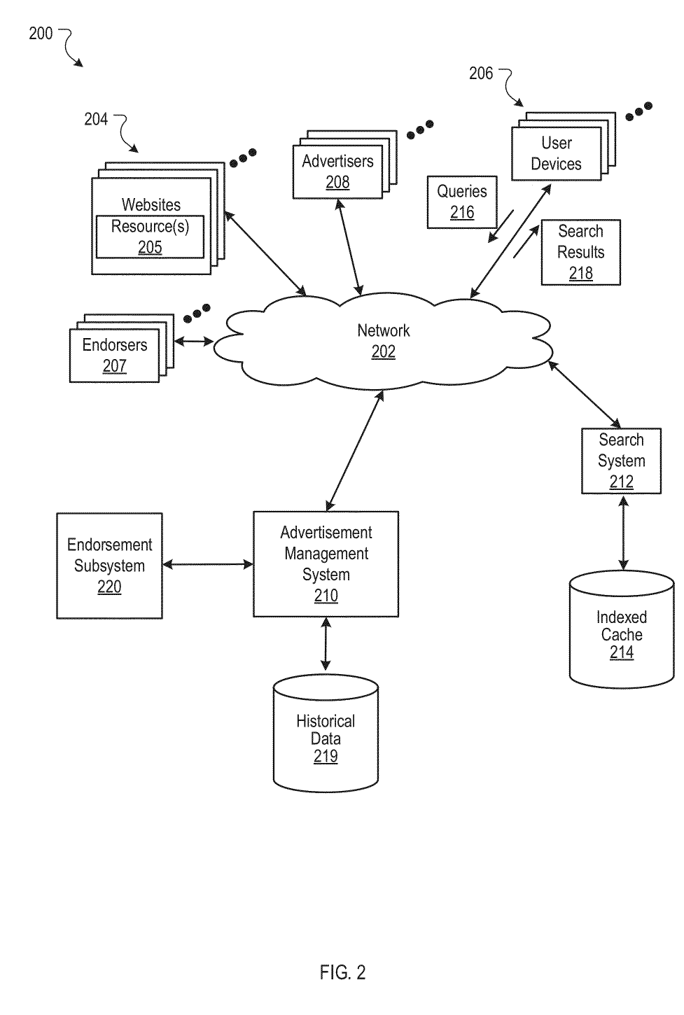

FIG. 2 is a block diagram of an example environment 200 in which an advertisement management system 210 manages advertising services. The example environment 200 includes a network 202 such as a local area network (LAN), wide area network (WAN), the Internet, or a combination thereof. The network 202 connects websites 204, user devices 206, endorsers 207, advertisers 208, and the advertisement management system 210. The example environment 200 may include many thousands of websites 204, user devices 206, endorsers 207, and advertisers 208.

A website 204 is one or more resources 205 associated with a domain name and hosted by one or more servers. An example website is a collection of webpages formatted in hypertext markup language (HTML) that can contain text, images, multimedia content, and programming elements, e.g., scripts. Each website 204 is maintained by a publisher, e.g., an entity that manages and/or owns the website 204.

A resource 205 is any data that can be provided over the network 202 and that is associated with a resource address. Resources include HTML pages, word processing documents, portable document format (PDF) documents, images, video, and feed sources, to name only a few. The resources can include content, e.g., words, phrases, images and audio that may include embedded information (such as meta-information in hyperlinks) and/or embedded instructions (such as JavaScript scripts).

A user device 206 is an electronic device that is under control of a user and is capable of requesting and receiving resources 205 over the network 202. Example user devices 206 include personal computers, mobile communication devices, and other devices that can send and receive data over the network 202. A user device 206 typically includes a user application, such as a web browser, to facilitate the sending and receiving of data over the network 202.

A user device 206 can request resources 205 from a website 204. In turn, data representing the resource 205 can be provided to the user device 206 for presentation by the user device 206. The data representing the resource 205 can also include data specifying a portion of the resource or a portion of a user display (e.g., a presentation location of a pop-up window) in which advertisements can be presented. These specified portions of the resource or user display in which advertisements can be presented are referred to as advertisement slots.

To facilitate searching of these resources, a search system 212 identifies the resources by crawling and indexing the resources provided by the publishers on the websites 204. The indexed and, optionally, cached copies of the resources are stored in an indexed cache 214.

User devices 206 submit search queries 216 to the search system 212 over the network 202. In response, the search system 212 accesses the indexed cache 214 to identify resources that are relevant to the search query 216. The search system 212 identifies the resources in the form of search results 218 and returns the search results 218 to the user devices 206 in search results pages.

A search result 218 is data generated by the search system 212 that identifies a resource that is responsive to a particular search query, and includes a link to the resource. An example search result 218 can include a webpage title, a snippet of text or a portion of an image extracted from the webpage, and the URL of the webpage. Search results pages can also include one or more advertisement slots in which advertisements can be presented.

When a resource 205 or search results 218 are requested by a user device 206, the advertisement management system 210 receives a request for advertisements to be provided with the resource or search results. The request for advertisements can include characteristics of the advertisement slots that are defined for the requested resource or search results page. Therefore, the advertisement management system 210 can use the characteristics to select advertisements for presentation in the advertisement slots.

For example, a reference (e.g., URL) to the resource for which the advertisement slot is defined, a size of the advertisement slot, and/or media types that are available for presentation in the advertisement slot can be provided to the advertisement management system 210. Similarly, a search query 216 for which search results are requested can also be provided to the advertisement management system 210.

An endorser 207 is a person or institution with trusted expertise is some category of products, services, or ideas, and who endorses these products, services, or ideas. Endorsers 207 can provide endorsements of advertisements that are the subject of the products, services, or ideas.

In response to the request for advertisements, the advertisement management system 210 can select, for presentation, advertisements having characteristics matching the characteristics of advertisement slots and that are identified as relevant to the search queries 216. The data representing the request for advertisements as well as data representing the selected advertisements, user actions (e.g., selections, conversions) taken in response to the selected advertisements being presented, endorsements of the advertisements, and recommendations of the endorsers that provided any endorsements can be stored in a historical data store 219. For example, data representing each endorsement associated with an advertisement as well as the data representing users who have recommended the endorsers associated with each endorsement can be stored in the historical date store 219.

Based on data included in the request for advertisements, the advertisement management system 210 can select advertisements that are eligible to be provided in response to the request. For example, eligible advertisements can include advertisements having characteristics matching the characteristics of advertisement slots and that are identified as relevant to specified resource keywords or search queries 216. In some implementations, advertisements having targeting keywords that match the resource keywords or the search query 216 are selected as eligible advertisements by the advertisement management system 210.

A targeting keyword can match a resource keyword or a search query 216 by having the same textual content (“text”) as the resource keyword or search query 216. For example, an advertisement associated with the targeting keyword “tennis” can be an eligible advertisement for an advertisement request including the resource keyword “tennis” Similarly, the advertisement can be selected as an eligible advertisement for an advertisement request including the search query “tennis.” A targeting keyword can also match a resource keyword or a search query 216 by having text that is identified as being relevant to a targeting keyword or search query 216 despite having different text than the targeting keyword. For example, an advertisement having the targeting keyword “tennis” may also be selected as an eligible advertisement for an advertisement request including a resource keyword or search query for “sports” because tennis is a type of sport, and therefore, is relevant to the term “tennis.”

The advertisement management system 210 can select the eligible advertisements that are provided for presentation in advertisement slots of a resource or search results page based on results of an auction. For example, the advertisement management system 210 can receive bids from advertisers and allocate the advertisement slots to the highest bidders at the conclusion of the auction. The bids are amounts that the advertisers are willing to pay for presentation (or selection) of their advertisement with a resource or search results page. For example, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement.

A conversion occurs when a user performs a particular action related to an advertisement provided with a resource or search results page. What constitutes a conversion may vary from case to case and can be determined in a variety of ways. For example, a conversion may occur when a user clicks on an advertisement, is referred to a webpage, and consummates a purchase there before leaving that webpage. A conversion can also be defined by an advertiser to be any measurable/observable user action such as, for example, downloading a white paper, navigating to at least a given depth of a website, viewing at least a certain number of webpages, spending at least a predetermined amount of time on a website or webpage, registering on a website. Other actions that constitute a conversion can also be used.

The highest bidders can be determined based on the bids alone, or based on the bids of each bidder being multiplied by one or more signals, such as relevancy scores derived from advertisement performance, landing page scores, endorsements of the advertisements, and recommendations of endorsers who provided the endorsements.

To facilitate selection and presentation of the eligible advertisement, the advertisement management system 210 includes an endorsement subsystem 220. The endorsement subsystem 220 receives endorsements of the advertisements from endorsers and associates the endorsements with the advertisements. The endorsement subsystem 220 can also receive recommendations of the endorsers. The endorsements and recommendations can be used during the auction process. For example, an advertisement score can be calculated for each advertisement based on the bid, a first score if an advertisement is associated with an endorsement, and a second score if the endorsement has been recommended by a user that is in the same social network as the user that provided the search query. The endorsement subsystem can then rank the eligible advertisements based the advertisement score.

The endorsement subsystem can present a predetermined number of the top ranking eligible advertisements in response to the request. If the advertisements are associated with an endorsement or if the endorser is associated with a recommendation, the endorsement data describing the endorsement and the recommendation data describing the recommendation are also provided in response to the request. When a selection of an advertisement associated with an endorsement is received, the endorser associated with the endorsement of the advertisement can be compensated.

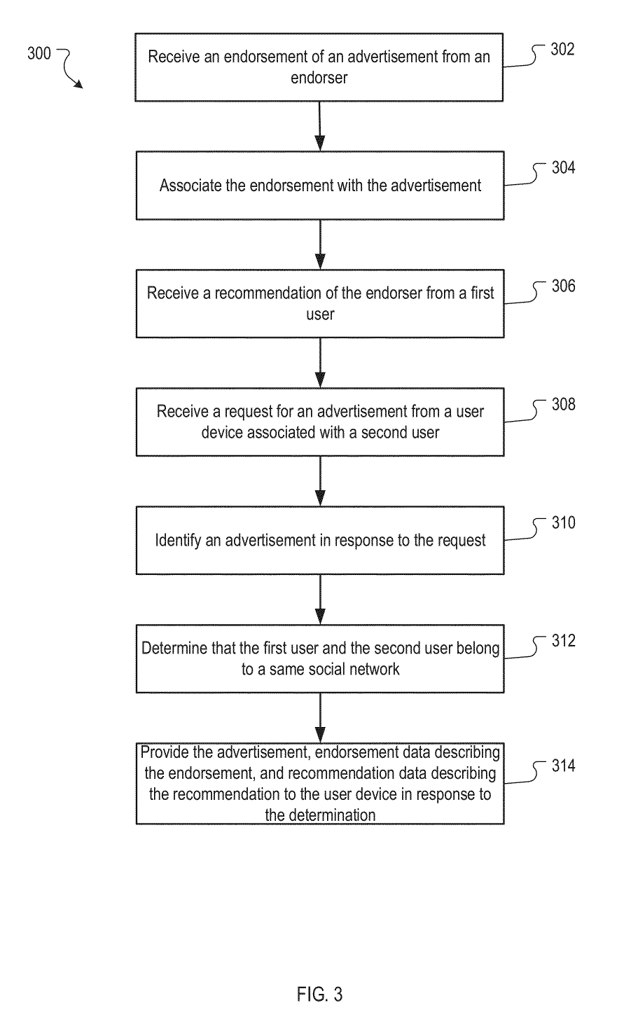

FIG. 3 is a block diagram of an example process flow 300 for providing advertisements associated with endorsements. According to the process 300, an endorsement of a good or service is received from an endorser, and a recommendation of the endorser is received from a first user. An advertisement associated with the good or service is identified in response to a request for an advertisement from a second user. A determination is made that the first user belongs to the same social network as a second user, and the identified advertisement, the endorsement data describing the endorsement, and the recommendation data describing the recommendation are provided to a user device of the second user.

The process 300 can be implemented, for example, by the endorsement subsystem 220 and/or the advertisement management system of FIG. 2. In some implementations, the endorsement subsystem 220 is a data processing apparatus that includes one or more processors that are configured to perform actions of the process 300. In other implementations, a computer readable medium can include instructions that when executed by a computer cause the computer to perform actions of the process 300.

An endorsement of a good or service is received from an endorser (302). In some implementations, the endorser has expertise in one or more category of goods, services or ideas associated with the good or service. For example, suppose endorser A has expertise in hotels and has provided an endorsement of a hotel in California. The same endorser A can also have expertise in cars and provide endorsements of cars.

In some implementations, an endorsement of an advertisement can be received. For example, an endorsement of an advertisement for a hotel in California can be received from endorser A as opposed to an endorsement of the actual hotel. In other implementations, an endorsement of an advertiser associated with an advertiser can be received. For example, an endorsement of an advertiser X that advertisers the hotel in California can be received.

In some implementations, the endorsers can be identified by the advertisement management system 210 using publishers that provide reviews of products and goods. For example, publishers such as Stereo Review, Car and Driver, Zagat Survey, Michelin Guide, New York Times and the like can be used as sources of endorsements. These reviews can be received by the advertisement management system 210 and the endorsers can be identified from the reviews. In other implementations, the advertisement management system 210 can select users to be endorsers.

An endorsement is an approval or support of a good, a service, an advertisement, or an advertiser associated with the advertisement. The endorsement subsystem 220 receives data indicating the endorsement. For example, endorser A can provide endorsements for hotels to indicate that endorser A approves of the hotels. The endorsement can also be accompanied by comments describing the endorsement. For example, endorser A can also provide comments indicating approval of the hotels, such as, “great hotel with great service.”

The endorsement can be associated with an advertisement associated with the good or service (304). In some implementations, the advertiser associated with the advertisement has indicated that endorsements can be associated with the advertisement. For example, an advertiser can create an advertisement creative in the advertisement management system 210 describing the advertisement. When creating the creative, the advertiser can indicate whether or not to allow endorsements to be associated with the advertisement. For example, an “allow endorsement” checkbox may be presented to the advertiser. If the advertiser checks this checkbox, and an endorser provides endorsement related to that advertisement, the endorsement describing the good or service associated with the advertisement may be associated with the advertisement.

The endorsement can be associated with the advertisement with an identification number. Each endorsement can include a unique identification number, and the identification number can be stored with the respective advertisement in the data store.

A recommendation of the endorser is received from a first user (306). In some implementations, the recommendation indicates whether or not the endorser provides credible endorsements of goods, services, or ideas. The recommendation can be in the format of a score indicating strength of the credibility of the endorser. For example, a number between 0 and 10 may be used, with a score of 0 being no credibility given to the endorser and a score of 10 being a highest credibility given to the endorser. The recommendation can also be in the form of a positive, neutral, or negative rating. For example, a positive rating indicates that the endorser is always credible, a neutral rating indicates that the endorser provides a mix of credible and false endorsement and the credibility is therefore neutral, and a negative rating indicates that the endorser is never credible. The recommendation can also be in the form of a binary recommendation indication. For example, an endorser can either be recommended or not recommended.

In some implementations, the recommendation for the endorser can be tied to a specific category of goods, services, or ideas when the endorser is associated with more than one category. For example, suppose endorser A endorsed hotel Spokane, and that Endorser A also provided an endorsement of a car retailer. Also suppose that Dave provides a positive recommendation for endorser A with regard to the endorsement associated with hotel Spokane. For example, Dave may have visited the hotel Spokane and thought the endorsement by endorser A was credible.

Dave can also provide a negative recommendation for endorser A with regard to the car retailer. Dave may have visited the car retailer and disagreed with endorser A's endorsement and therefore thought that the endorsement of the car retailer was not credible.

In other implementations, the recommendation of the endorser is tied to any endorsements related to any goods, services, or ideas of advertisements. Therefore, whenever a recommendation of an endorser is received, the recommendation applies to any endorsement of any advertisements regardless of the category associated with the advertisement.

A request for an advertisement is received from a user device associated with a second user (308). In some implementations, the request includes the keywords used in a search query. For example, a user Jeff can submit a search query for “hotels Spokane.”

An advertisement is identified in response to the request (310). In some implementations, the advertisement includes keywords that satisfy the search query. For example, advertisement A about hotel Spokane is associated with keywords such as “hotel,” “Spokane,” and “comfort.” Therefore, the keywords “hotel” and “Spokane” match the search query keywords “hotel Spokane,” and the advertisement A about hotel Spokane is identified in response to the search query “hotels Spokane.”

A determination is made that the first user and the second user are in a same social network (312). For example, Dave and Jeff may both belong to the social network Twitter. In some implementation, a determination is made that the first user and the second user share an acquaintance relationship in the same social network. The acquaintance relationship is one that is agreed to by both users. For example, Dave and Jeff may both belong to the social network Orkut, and both may have agreed to form an acquaintance relationship within Orkut.

The advertisement, endorsement data describing the endorsement, and recommendation data describing the recommendation are provided to the user device in response to the determination that the first user that belongs to the same social network as the second user (314). In some implementations, the advertisement, the endorsement data and the recommendation data are sent to the user device of the second user at the same time from the advertisement management system. For example, once a request for an advertisement is received, the advertisement, the endorsement data and the recommendation data are sent without initiation of a second request to the advertisement management system. For example, advertisement A, endorser A's endorsement, and Dave's recommendation are sent to the user device at the same time by the advertisement management system.

The endorsement data and the recommendation data are displayed proximate to the advertisement on a webpage displayed on the user device. For example, endorser A's endorsement can be represented by a checkmark or an asterisk proximate to advertisement A about Hotel Spokane. Dave's recommendation of endorser A can be represented as well by a checkmark or an asterisk proximate to advertisement A.

In some implementations, the second user can provide an indication that he does not want to receive endorsements with advertisements. For example, Jeff can decide that he does not want to see endorsements of advertisements when advertisements are presented. Therefore, the endorsement data and the recommendation data are precluded from being provided to the client device upon receipt of the user indication indicating that the user does not want to receive endorsements. For example, if Jeff had indicated that he did not want to see endorsements, when advertisement A is presented to him, the endorsement of endorser A and the recommendation of endorser A by Dave are not presented on the webpage to Jeff.

In some implementations, the second user can provide an indication to allow only certain people in his social network to provide recommendations. For example, Jeff may respect Chris's taste in food, so he allows Chris to recommend food-related endorsers.

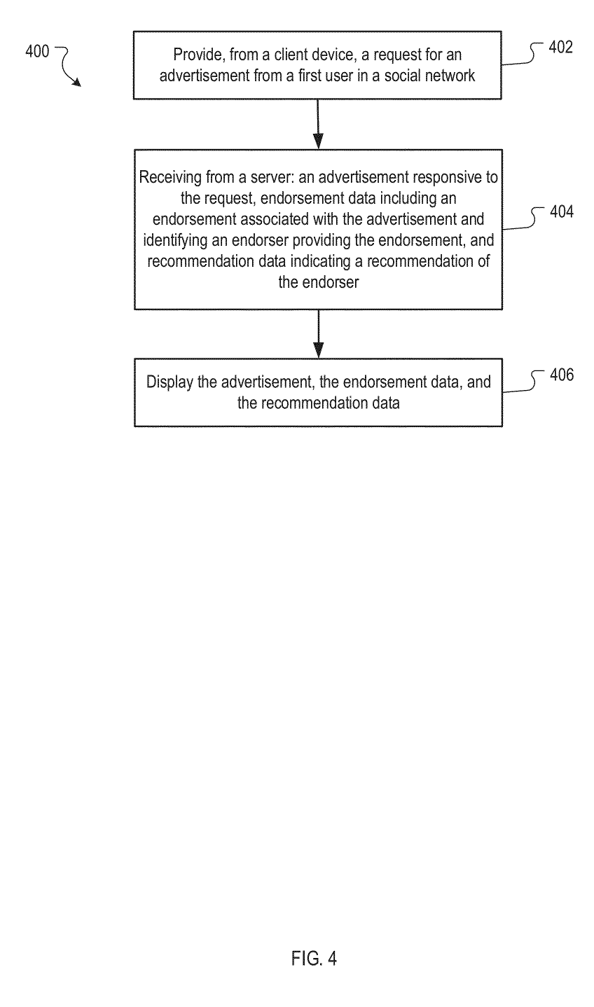

FIG. 4 is a block diagram of an example process flow 400 for receiving and displaying advertisements associated with endorsements. According to the process 400, a request for an advertisement is provided from a first user in a social network. The advertisement responsive to the request, the endorsement data identifying the endorsement and the recommendation data indicating a recommendation of the endorser are received from a server, and the advertisement the endorsement data and the recommendation data are displayed on a client device.

The process 400 can be implemented, for example by the endorsement subsystem 220 and/or the advertisement management system of FIG. 2. In some implementations, the endorsement subsystem 220 is a data processing apparatus that includes one or more processors that are configured to perform actions of the process 400. In other implementations, a computer readable medium can include instructions that when executed by a computer cause the computer to perform actions of the process 400.

A request for an advertisement from a first user in a social network is provided from a client device (402). In some implementations, the request includes a search query including one or more keywords provided by a user on a webpage and is received at a server. For example, the request includes “hotels Spokane” on a search engine webpage and is received by the advertisement management system 210.

An advertisement responsive to the request, endorsement data including an endorsement associated with a good or service associated with the advertisement and identifying an endorser providing the endorsement, and recommendation data indicating a recommendation of the endorser are received from the server (404). In some implementations, the recommendation data is provided by a second user belong to the same social network as the first user, where the recommendation is received from a server in response to determining that the first user and the second user belong to the same social network. For example, advertisement A about hotel Spokane, endorser A's endorsement, and Dave's recommendation of endorser A are received at the client device. As discussed above, Dave and Jeff are in the same social network.

The advertisement, the endorsement data, and the recommendation data are displayed at the client device (406). In some implementations, the advertisement, the endorsement data and the recommendation data are displayed simultaneously at the client device. For example, the advertisement for Hotel A, endorser A's endorsement and Dave's recommendation of endorser A are displayed for user Jeff on the search engine webpage.

In other implementations, only the advertisement and the endorsement data are provided at the client device. The recommendation data is only provided upon receipt of an indication from the user who performed the search to be able to view any recommendations of endorsers associated with advertisements that are presented. For example, only advertisement A and endorser A's endorsement are presented on the search engine webpage. Dave's recommendation of endorser A can be presented upon receipt of an indication by Mike to be able to see recommendations of endorsers.

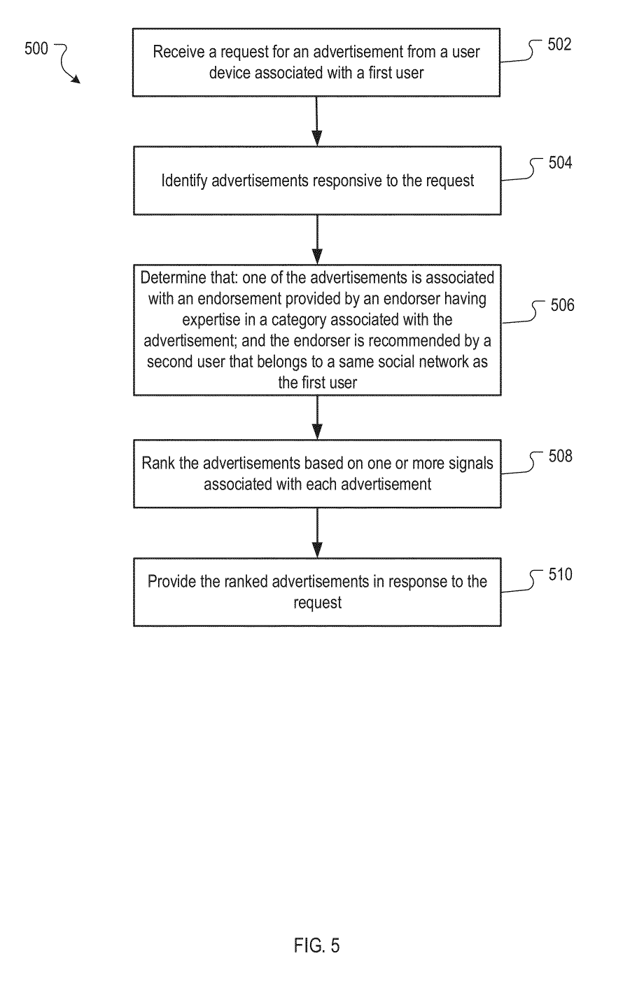

FIG. 5 is a block diagram of an example process flow 500 for providing ranked advertisements. According to the process 500, a request for an advertisement is received from a user device associated with a first user, and advertisements responsive to the request are identified. A determination is made that one of the advertisements describes a good or service that is associated with an endorsement provided by an endorser, where the endorser is recommended by a second user that belongs to the same social network as the first user. The advertisements are ranked based on one or more signals associated with each advertisement, where one of the signals for the one advertisement is the endorsement and the endorsement is used in the ranking. The ranked advertisements are then provided in response to the request.

The process 500 can be implemented, for example by the endorsement subsystem 220 and/or the advertisement management system of FIG. 2. In some implementations, the endorsement subsystem 220 is a data processing apparatus that includes one or more processors that are configured to perform actions of the process 500. In other implementations, a computer readable medium can include instructions that when executed by a computer cause the computer to perform actions of the process 500.

A request for an advertisement from a user device associated with a first user is received (502). In some implementations, the request includes the terms in a search query. For example, Jeff can provide the search query “hotels Spokane.” The terms “hotels Spokane” can be used to identify the advertisement.

Advertisements are identified responsive to the request (504). In some implementations, eligible advertisements with keywords that satisfy the terms in the search query are identified. For example, any advertisement that is associated with a keyword “hotel” or “Spokane” can be identified as responsive to the request. Suppose the following advertisements were identified in response to the request:

| | | | | | | Rec- |
|---|---|---|---|---|---|---|
| | Cate- | | | Relevancy | Endorse- | ommen- |
| | gory | Keywords | Bid | Score | ment | dation |
| Adver- | Hotel | Hotel | $.50 | 2 | Endorser A | Dave |
| tisement | | Spokane | | | | |
| A | | | | | | |
| Adver- | Hotel | Hotel | $.90 | 2 | Endorser A | Eve |
| tisement | | Spokane | | | | |
| B | | | | | | |

Advertisement A is identified because the advertisement is associated with the keywords “hotel” and “Spokane.” Each of the advertisements is also associated with a category. For example, advertisement A is associated with the category hotels. Advertisement B is also identified because the advertisement is associated with the keywords “hotel” and “Spokane” and advertisement B is also associated with the category hotels.

A determination is made that one of the advertisements describes a good or service that is associated with an endorsement provided by an endorser, and the endorser is recommended by a second user that belongs to a same social network as the first user (506). The endorsement can be received from the endorser and associated with an advertisement describing the good or service. The endorsement can also be associated with a recommendation of the endorser.

For example, endorser A has provided an endorsement of the hotel described in advertisement A which is about a hotel in Spokane. The endorsement subsystem receives the endorsement of the hotel described in advertisement A from endorser A and associates the endorsement with advertisement A. Furthermore, endorser A has been recommended by Dave, who is in Jeff's social network and shares an acquaintance relationship with Jeff. The hotel in advertisement B has been endorsed by Endorser B, who has been recommended by Eve. Eve is in the same social network as Jeff but does not share an acquaintance relationship with him.

The advertisements are ranked based on one or more signals associated with each advertisement, with one of the signals for an advertisement being an endorsement that is used in the ranking in response to the determination (508). In some implementations, the signals include the keywords associated with the advertisement, a quality of the landing page, a bid associated with each advertisement, and whether the good or product described in the advertisement is associated with an endorsement.

A score can be calculated using the signals. One of the signals can include an endorsement weight. The weight can represent the number of endorsements. For example, if an advertisement is associated with one endorsement, the endorsement weight of the advertisement is 1. If an advertisement is associated with five endorsements, then the endorsement weight for that advertisement is 5.

An advertisement score can be calculated for each advertisement based on the one or more signals. For example, the advertisement score can be a combination of the bid, relevancy score, and the endorsement weight such as:

Advertisement score=bid*quality score+endorsement weight

Using this formula the advertisement score of each of the advertisements is as follows:

Advertisement A score=0.5*2+1=2

Advertisement B score=0.9*2+1=2.8

Therefore advertisement B has a higher score than advertisement A.

In some implementations, if the endorsement has been recommended by a user in the same social network as the user who provided the search query, a recommendation weight can be added to the advertisement score. The recommendation weight of the advertisement can be a numerical value representing the number of recommendations. Therefore, the advertisement score can be calculated as follows:

Advertisement score=bid*quality score+endorsement weight+recommendation weight

In the above example, Jeff submitted the query for “hotel Spokane” and he is in social network A and has an acquaintance relationship with Dave. Since Dave is in Jeff's social network, the recommendation weight of advertisement A is 1. The hotel in advertisement B has been endorsed by endorser B. However while Eve is in social network A, she does not share an acquaintance relationship with Jeff. Therefore, the recommendation weight of advertisement B is 0. Therefore, the advertisement score using the recommendation weights is calculated as follows:

Advertisement A score=0.5*2+1+1=3

Advertisement B score=0.9*2+1+0=2.8

In this case, advertisement A has a higher score than advertisement B, which means that advertisement A is a more desirable advertisement that advertisement B when the recommendation of the endorsers are taken into consideration, and is a less desirable advertisement when the recommendations are not taken into consideration.

The ranked advertisements are provided in response to the request (510). In some implementations, the advertisements are ranked based on the scores calculated using the signals including the endorsement weight, but not the recommendations weight. For example, in the example above, the ranked advertisements would be displayed with advertisement B first and then advertisement A.

In other implementations, the advertisements are ranked based on the scores calculated including the endorsement weight and the recommendation weight. For example, in the example above, the ranked advertisements would be displayed with advertisement A first and then advertisement B.

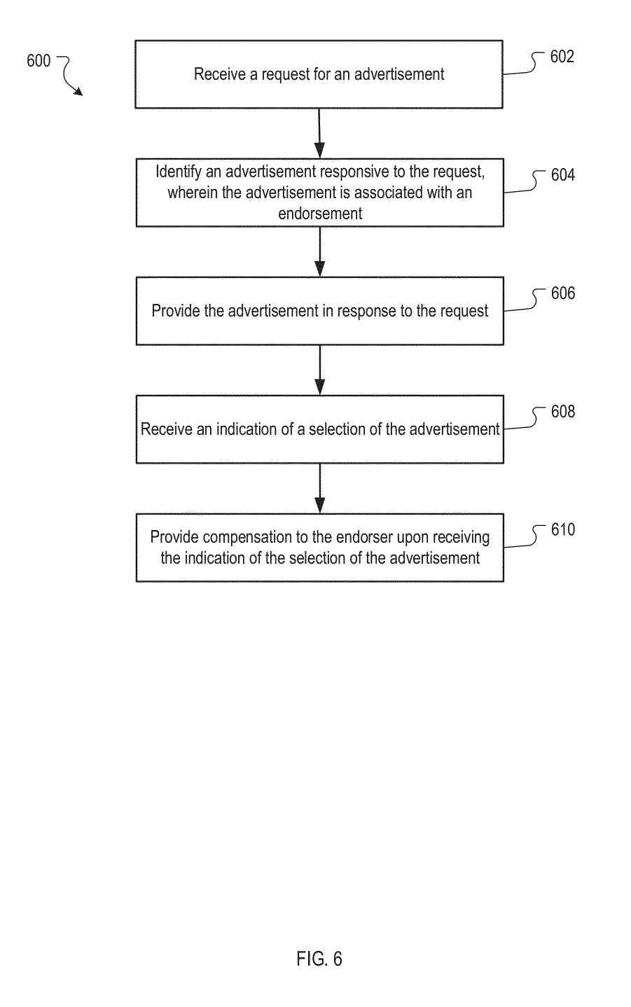

FIG. 6 is a block diagram of an example process flow 600 for providing compensation to endorsers of advertisements. According to the process 600, a request for an advertisement is received. An advertisement responsive to the request is identified, where a good or service associated with the advertisement is associated with an endorsement provided by an endorser who may have expertise in a category associated with the good or service. The advertisement is provided in response to the request, and an indication of a selection of the advertisement is received. Compensation is provided to the endorser upon receiving the indication of the selection of the advertisement.

The process 600 can be implemented, for example, by the endorsement subsystem 220 and/or the advertisement management system of FIG. 2. In some implementations, the endorsement subsystem 220 is a data processing apparatus that includes one or more processors that are configured to perform actions of the process 600. In other implementations, a computer readable medium can include instructions that when executed by a computer cause the computer to perform actions of the process 600.

A request for an advertisement is received (602). In some implementations, the request includes a search query including one or more keywords and is received at a server. For example, the request may include “hotels Spokane.”

An advertisement responsive to the request is identified, with a good or service associated with the advertisement being associated with an endorsement provided by an endorser who may have expertise in a category associated with the good or service (604). For example, as discussed above, the advertisement A for Hotel Spokane can be identified in response to Jeff's search for “hotels Spokane.”

The advertisement is provided in response to the request (606). As discussed above, the advertisement can include keywords that satisfy the search query. For example, advertisement A about hotel Spokane can include keywords such as “hotel,” “Spokane,” and “comfort.” Therefore, the keywords “hotel” and “Spokane” match the search query “hotel Spokane” and the advertisement A about hotel Spokane is identified. In some implementations, the advertisement is only provided if the user (i.e., Jeff) and the person (i.e., Dave) who recommended the endorser are in the same social network and share an acquaintance relationship.

An indication of a selection of the advertisement is received (608). In some implementations, the user can select a creative associated with the advertisement or a link to a landing page associated with the advertisement. For example, Jeff can select any part of the creative for advertisement A for hotel Spokane and be taken to a webpage for hotel Spokane. Alternatively, Jeff can select the URL for the landing page and be taken to the webpage for hotel Spokane.

Compensation is provided to the endorser upon receiving the indication of the selection of the advertisement (610). In some implementations, the compensation can be based on a percentage of the cost-per-click associated with the advertisement. For example, 10% of the cost-per-click associated with advertisement A can be given to Dave when Jeff selects the advertisement A. Alternatively, the compensation can be based on a percentage of the CPM associated with the advertisement or other factors. In some implementations, the compensation is provided only if the advertisement is provided to a first user who has an acquaintance relationship in a social network with a second user who provided the recommendation. For example, the compensation is provided to endorser A only if Jeff, the user who submitted the query, and Dave, the user who recommended endorser A, have an acquaintance relationship in the social network A. If Jeff and Dave did not have an acquaintance relationship in social network A, even though Jeff clicked on advertisement A, endorser A would not be compensated.

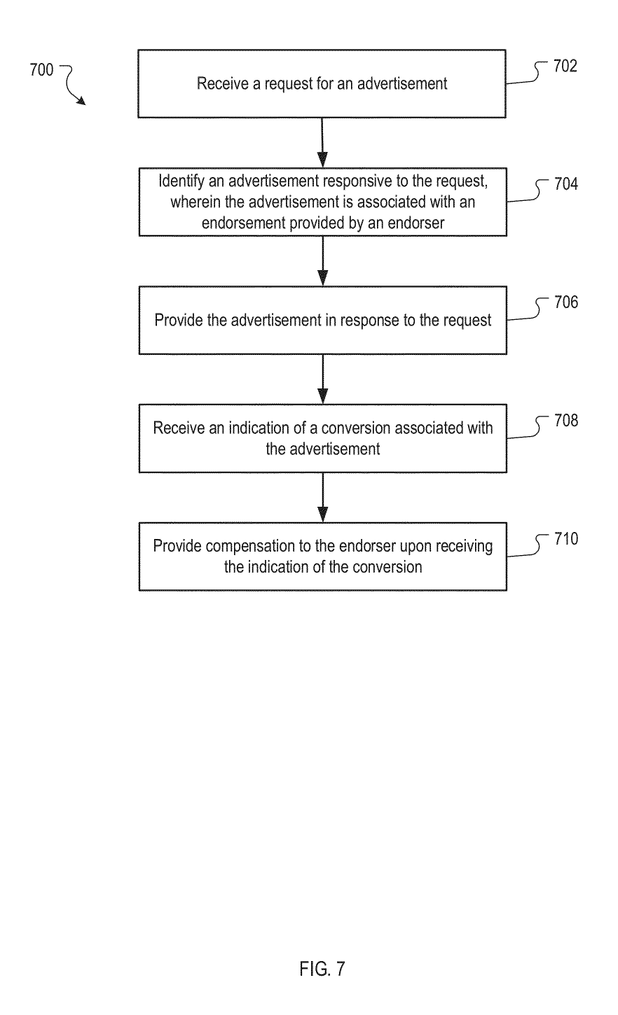

FIG. 7 is a block diagram of an example process flow 700 for providing advertisements associated with endorsements. According to the process 700, a request for an advertisement is received. An advertisement responsive to the request is identified, with a good or service associated with the advertisement being associated with an endorsement provided by an endorser who may have expertise in a category associated with the good or service. The advertisement is provided in response to the request. An indication of a conversion associated with the advertisement is received, and compensation is provided to the endorser upon receiving the indication of the conversion.

The process 700 can be implemented, for example by the endorsement subsystem 220 and/or the advertisement management system of FIG. 2. In some implementations, the endorsement subsystem 220 is a data processing apparatus that includes one or more processors that are configured to perform actions of the process 700. In other implementations, a computer readable medium can include instructions that when executed by a computer cause the computer to perform actions of the process 700.

A request for an advertisement is received (702). An advertisement responsive to the request is identified, where a good or service associated with the advertisement is associated with an endorsement provided by an endorser who may have expertise in a category associated with the good or service associated with the advertisement (704). In some implementations, the endorsement subsystem 220 can identify a first user associated with the request for the advertisement, identify a second user who provided the recommendation, determine whether the first user and the second user share an acquaintance relationship in a social network, and then provide the advertisement in response to the request based on the determination. For example, upon a determination that Jeff, the user who provided the search query, and Dave, the user who provided the recommendation of endorser A who endorsed the good or service in advertisement A, share an acquaintance relationship in a social network, the endorsement subsystem 220 can identify advertisement A in response to the request.

The advertisement is provided in response to the request (706). For example, advertisement A is provided to Jeff in response to his search for “hotels Spokane.”

An indication of a conversion associated with the advertisement is received (708). In some implementations, the conversion indicates that the user purchased an item associated with the advertisement. The purchase can be associated with a landing page related to the advertisement. For example, Jeff can purchase a night in the Hotel Spokane after being taken to the hotel's website after clicking on the advertisement A. Jeff's purchase can be considered a conversion.

Compensation is provided to the endorser upon receiving the indication of the conversion (710). In some implementations, the compensation can be a portion of the cost-per-click associated with the advertisement as discussed above. For example, 20% of the cost-per-click of advertisement A can be given to endorser A if Jeff purchases a night at the Hotel Spokane. The compensation does not need to be based on whether the user who provided the query shares a social network acquaintance relationship with the user who provided the recommendation. For example, if Jeff selected advertisement B, which was endorsed by endorser B and was recommended by Eve, endorser B would still be compensated even though Eve and Jeff do not share an acquaintance relationship with each other in social network A.

In other implementations, the compensation is based on the user who provided the query and the user who provided the recommendation being in the same social network and sharing an acquaintance relationship. Therefore, if Jeff selected advertisement B, endorser B would not be compensated because Eve and Jeff do not share an acquaintance relationship with each other in social network A.

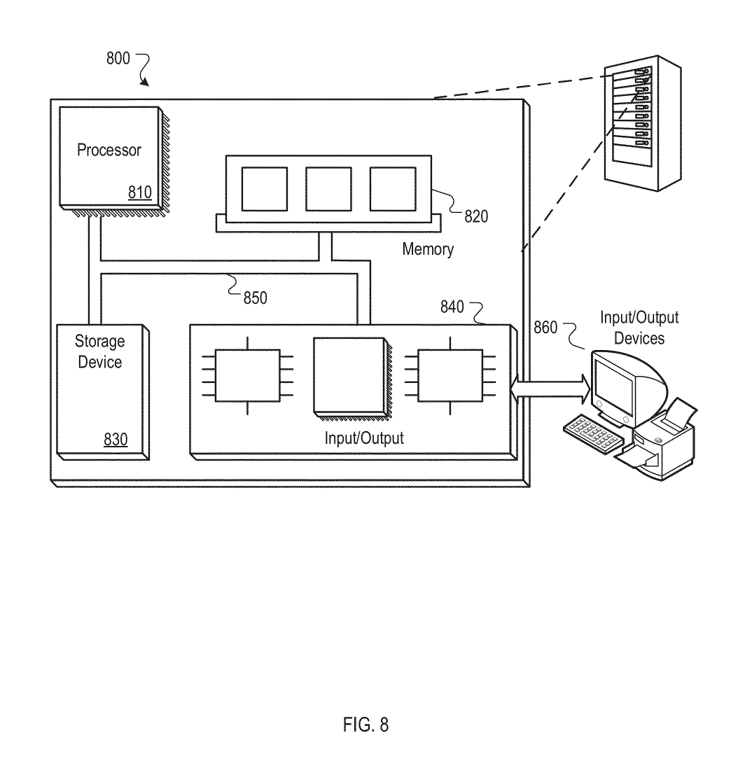

FIG. 8 is block diagram of an example computer system 800 that can be used to allocate resources in response to resource requests. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can include, for example, a hard disk device, an optical disk device, or some other large capacity storage device.

The input/output device 840 provides input/output operations for the system 800. In one implementation, the input/output device 840 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 860. Other implementations, however, can also be used, such as mobile computing devices, mobile communication devices, set-top box television client devices, and the like.

The endorsement subsystem 220 and/or advertisement management system 210 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The endorsement subsystem 220 and/or advertisement management system 210 can be distributively implemented over a network, such as a server farm, or can be implemented in a single computer device.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1.-21. (canceled)

22. A computer-implemented method comprising:
identifying, by one or more computer systems comprising one or more processors and a database management system, first content to provide to a first user based on a request from the first user, wherein the first content is provided by a first content provider;
determining, by the one or more computer systems, that an endorser has endorsed an object that is identifiable from text or images within the first content, wherein the first content provider differs from the endorser;
determining, by the one or more computer systems, that a recommending user has affirmatively recommended the endorser by performing an online user action indicating the recommending user's trust in the endorser;
analyzing, by the one or more computer systems, a social graph formed in a data structure, including: identifying nodes representing users of a social network and connections among the nodes in the social graph;
determining, by the one or more computer systems based on the analyzing, that the first content is to be distributed to the first user based on a determination that a first node representing the first user in the social graph is one degree of separation from a second node representing the recommending user in the social graph for the social network; and
transmitting, by the one or more computer systems and to a client device of the first user, data that presents a graphical user interface on a display of the client device, wherein the graphical user interface visually presents the first content, an indication that the object identifiable in the first content was endorsed by the endorser, and an indication that the recommending user has affirmatively recommended the endorser and that the recommending user is connected in the social network to the first user,
wherein the graphical user interface enables connection to a remote server over the Internet based on user interaction with the indication that the object was endorsed by the endorser and when the client device is online.

23. The method of claim 22, further comprising:
receiving, from the endorser, an endorsement of the first content; and
associating the endorsement with the first content.

24. The method of claim 22, further comprising determining that an endorsement is associated with a recommendation of the endorser.

25. The method of claim 22, further comprising:
identifying the first user who provided the request for the first: and
identifying the recommending user who provided a recommendation of the endorser.

26. The method of claim 22, wherein the endorser has expertise in a category associated with a good or a service that is associated with the first content.

27. The method of claim 22, further comprising:
ranking content including the first content based on signals associated with each item of content, wherein one of the signals for the first content is information specifying that the endorser is recommended by the recommending user who belongs to the same social network as the first user; and
providing the ranked content in response to the request.

28. A system comprising:
one or more computers; and
a computer-readable medium coupled to the one or more computers having instructions stored thereon which, when executed by the one or more computers, cause the one or more computers to perform operations comprising:
identifying first content to provide to a first user based on a request from the first user, wherein the first content is provided by a first content provider;
determining that an endorser has endorsed an object that is identifiable from text or images within the first content, wherein the first content provider differs from the endorser;
determining that a recommending user has affirmatively recommended the endorser by performing an online user action indicating the recommending user's trust in the endorser;
analyzing a social graph formed in a data structure, including: identifying nodes representing users of a social network and connections among the nodes in the social graph;
determining, based on the analyzing, that the first content is to be distributed to the first user based on a determination that a first node representing the first user in the social graph is one degree of separation from a second node representing the recommending user in the social graph for the social network; and
transmitting, to a client device of the first user, data that presents a graphical user interface on a display of the client device, wherein the graphical user interface visually presents the first content, an indication that the object identifiable in the first content was endorsed by the endorser, and an indication that the recommending user has affirmatively recommended the endorser and that the recommending user is connected in the social network to the first user,
wherein the graphical user interface enables connection to a remote server over the Internet based on user interaction with the indication that the object was endorsed by the endorser and when the client device is online.

29. The system of claim 28, wherein the operations further comprise:
receiving, from the endorser, an endorsement of the first content; and
associating the endorsement with the first content.

30. The system of claim 28, wherein the operations further comprise determining that an endorsement is associated with a recommendation of the endorser.

31. The system of claim 28, wherein the operations further comprise:
identifying the first user who provided the request for the first: and
identifying the recommending user who provided a recommendation of the endorser.

32. The system of claim 28, wherein the endorser has expertise in a category associated with a good or a service that is associated with the first content.

33. The system of claim 28, wherein the operations further comprise:
ranking content including the first content based on signals associated with each item of content, wherein one of the signals for the first content is information specifying that the endorser is recommended by the recommending user who belongs to the same social network as the first user; and
providing the ranked content in response to the request.

34. A computer storage medium encoded with a computer program, the program comprising instructions that when executed by data processing apparatus cause the data processing apparatus to perform operations comprising:
identifying first content to provide to a first user based on a request from the first user, wherein the first content is provided by a first content provider;
determining that an endorser has endorsed an object that is identifiable from text or images within the first content, wherein the first content provider differs from the endorser;
determining that a recommending user has affirmatively recommended the endorser by performing an online user action indicating the recommending user's trust in the endorser;
analyzing a social graph formed in a data structure, including: identifying nodes representing users of a social network and connections among the nodes in the social graph;
determining, based on the analyzing, that the first content is to be distributed to the first user based on a determination that a first node representing the first user in the social graph is one degree of separation from a second node representing the recommending user in the social graph for the social network; and
transmitting, to a client device of the first user, data that presents a graphical user interface on a display of the client device, wherein the graphical user interface visually presents the first content, an indication that the object identifiable in the first content was endorsed by the endorser, and an indication that the recommending user has affirmatively recommended the endorser and that the recommending user is connected in the social network to the first user,
wherein the graphical user interface enables connection to a remote server over the Internet based on user interaction with the indication that the object was endorsed by the endorser and when the client device is online.

35. The computer storage medium of claim 34, wherein the operations further comprise:
receiving, from the endorser, an endorsement of the first content; and
associating the endorsement with the first content.

36. The computer storage medium of claim 34, wherein the operations further comprise determining that an endorsement is associated with a recommendation of the endorser.

37. The computer storage medium of claim 34, wherein the operations further comprise:
identifying the first user who provided the request for the first: and
identifying the recommending user who provided a recommendation of the endorser.

38. The computer storage medium of claim 34, wherein the endorser has expertise in a category associated with a good or a service that is associated with the first content.

39. The computer storage medium of claim 34, wherein the operations further comprise:
ranking content including the first content based on signals associated with each item of content, wherein one of the signals for the first content is information specifying that the endorser is recommended by the recommending user who belongs to the same social network as the first user; and
providing the ranked content in response to the request.
